(19) United States
(12) Patent Application Publication
(10) Pub. No.: US 2013/0226671 A1
(43) Pub. Date: Aug. 29, 2013

(54) SYSTEMS AND METHODS FOR PROVIDING DEPENDENCY INJECTION IN A BUSINESS PROCESS MODEL SYSTEM

(71) Applicants: Jiri Pechanec, Mokra-Horakov (CZ); Martin Vecera, Brno (CZ)

(72) Inventors: Jiri Pechanec, Mokra-Horakov (CZ); Martin Vecera, Brno (CZ)

(21) Appl. No.: 13/407,872

(22) Filed: Feb. 29, 2012

(51) Int. Cl. G06Q 10/06

(52) U.S. Cl. 705/7.36

(57) ABSTRACT

A mechanism for providing dependency injection in a business process model (BPM) system is disclosed. A method includes receiving, by a computing device hosting the BPM system, a process and a plurality of parameters of the process. The method also includes retrieving, by the computing device, sub-processes associated with the process from a content repository of the computing device. The method further includes generating, by the computing device, metadata for one or more of the retrieved sub-processes based on the plurality of parameters. The generated metadata is used to select, based on a variable of the process, a sub-process of the processes for injection into the process when the process is executed.

### TECHNICAL FIELD

The embodiments of the invention relate generally to a computer system and, more specifically, relate to a mechanism for providing dependency injection in a business process model (BPM) system.

### BACKGROUND

Business process modeling (BPM) is a mechanism that creates business process models, while at the same time handling the complexity inherent to business processes. BPM is designed to coordinate a sequence of processes and messages that flow between different process participants in a related set of activities.

In a BPM system, large and complex processes can be built and modeled using application source codes. A process, as defined in the BPM, is a series of steps or activities performed to achieve a business goal. The process may include one or more sub-processes, which are linked to from the main process. A sub-process is a step or activity performed in the parent process, which includes an incoming connection and an outgoing connection. A sub-process is typically named or identified by a unique identifier. A sub-process is typically linked to from the parent process by using the unique name or identifier of the sub-process. In this manner, a tight-coupling between a process and its associated sub-processes is created in a BPM system.

Currently, in BPM systems, any modification of a sub-process during execution of the parent process results in a change of the application source code of the process. Changing the entire application source code of a process in a BPM system is a complex task that can consume a great deal of time and is prone to cause errors.

### BRIEF DESCRIPTION OF THE DRAWINGS

The invention will be understood more fully from the detailed description given below and from the accompanying drawings of various embodiments of the invention. The drawings, however, should not be taken to limit the invention to the specific embodiments, but are for explanation and understanding of the various embodiments of the invention.

FIG. 1 illustrates an exemplary network architecture in which embodiments of the invention may operate;

FIG. 2 is a block diagram of one embodiment of a BPM system;

FIG. 3 is a flow diagram of one embodiment of a method for providing dependency injection in the BPM system;

FIG. 4 is a flow diagram of one embodiment of a method for providing dependency injection in the BPM system;

FIG. 5 illustrates a block diagram representation of a machine in the exemplary form of a computer system.

### DETAILED DESCRIPTION

Embodiments of the invention provide a mechanism for dependency injection in a business process model system. A method of embodiments of the invention includes receiving, by a computing device hosting a business process model (BPM) system, a process and a plurality of parameters of the process; retrieving, by the computing device, sub-processes associated with the process from a content repository of the computing device and generating, by the computing device, metadata for one or more of the retrieved sub-processes based on the plurality of parameters. The generated metadata is used to select, based on a variable of the process, a sub-process of the processes for injection into the process when the process is executed.

In the following description, numerous details are set forth. It will be apparent, however, to one skilled in the art, that the present invention may be practiced without these specific details. In some instances, well-known structures and devices are shown in block diagram form, rather than in detail, in order to avoid obscuring the present invention.

Some portions of the detailed descriptions which follow are presented in terms of algorithms and symbolic representations of operations on data bits within a computer memory. These algorithmic descriptions and representations are the means used by those skilled in the data processing arts to most effectively convey the substance of their work to others skilled in the art. An algorithm is here, and generally, conceived to be a self-consistent sequence of steps leading to a desired result. The steps are those requiring physical manipulations of physical quantities. Usually, though not typically, these quantities take the form of electrical or magnetic signals capable of being stored, transferred, combined, compared, and otherwise manipulated. It has proven convenient at times, typically for reasons of common usage, to refer to these signals as bits, values, elements, symbols, characters, terms, numbers, or the like.

It should be borne in mind, however, that all of these and similar terms are to be associated with the appropriate physical quantities and are merely convenient labels applied to these quantities. Unless specifically stated otherwise, as apparent from the following discussion, it is appreciated that throughout the description, discussions utilizing terms such as “sending”, “receiving”, “retrieving”, “injecting”, “identifying”, “executing”, “updating” determining”, “initiating”, “generating” “comparing”, “searching”, “storing” or the like, refer to the action and processes of a computer system, or similar electronic computing device, that manipulates and transforms data represented as physical (electronic) quantities within the computer system's registers and memories into other data similarly represented as physical quantities within the computer system memories or registers or other such information storage, transmission or display devices.

The present invention also relates to an apparatus for performing the operations herein. This apparatus may be constructed for the specific purposes, or it may comprise a general purpose computer selectively activated or reconfigured by a computer program stored in the computer. Such a computer program may be stored in a machine readable storage medium, such as, but not limited to, any type of disk including floppy disks, optical disks, CD-ROMs, and magnetic-optical disks, read-only memories (ROMs), random access memories (RAMs), EPROMs, EEPROMs, magnetic or optical cards, or any type of media suitable for storing electronic instructions, each coupled to a computer system bus.

The algorithms and displays presented herein are not inherently related to any particular computer or other apparatus. Various general purpose systems may be used with programs in accordance with the teachings herein, or it may prove convenient to construct an apparatus to perform the method steps. The structure for a variety of these systems will appear as set forth in the description below. In addition, the present invention is not described with reference to any particular programming language. It will be appreciated that a variety of programming languages may be used to implement the teachings of the invention as described herein.

The present invention may be provided as a computer program product, or software, that may include a machine-readable medium having stored thereon instructions, which may be used to program a computer system (or other electronic devices) to perform a process according to the present invention. A machine-readable medium includes any mechanism for storing or transmitting information in a form readable by a machine (e.g., a computer). For example, a machine-readable (e.g., computer-readable) medium includes a machine (e.g., a computer) readable storage medium (e.g., read only memory (“ROM”), random access memory (“RAM”), magnetic disk storage media, optical storage media, flash memory devices, etc.), etc.

Embodiments of the invention provide systems and methods for providing dependency injection in a business process model system. A dependency injection module is initialized on a host operating system.

In one embodiment, the dependency injection module receives a process including parameters that trigger the generation of metadata for one or more sub-processes associated with the process. The sub-processes are stored in a content repository. The dependency injection module retrieves the one or more sub-processes from the content repository and generates the metadata based on the parameters. The one or more sub-processes and the metadata for the one or more sub-processes are stored in the content repository.

In another embodiment, the dependency injection module receives a process including parameters that may trigger an update of the metadata for one or more sub-processes associated with the process. The sub-processes and the metadata for the sub-processes are stored in a content repository. The dependency injection module retrieves and updates the metadata for the one or more sub-processes. The one or more sub-processes and the updated metadata for the one or more sub-processes are stored in the content repository.

In a further embodiment, the dependency injection module receives a request to execute a process, where the request to execute the process includes metadata associated with the execution of the process. The dependency injection initiates the execution of the process. During this initiation stage, the dependency injection retrieves one or more sub-processes along with the sub-processes' associated previously-generated metadata. The sub-processes/sub-process metadata are associated with the requested process. During execution of the process, the dependency injection compares the retrieved metadata for the one or more sub-processes with the metadata associated with the execution of the process received in the request. Upon determining a match between a sub-process's metadata and the metadata associated with the execution of the process, the dependency injection injects the matching sub-process into the process.

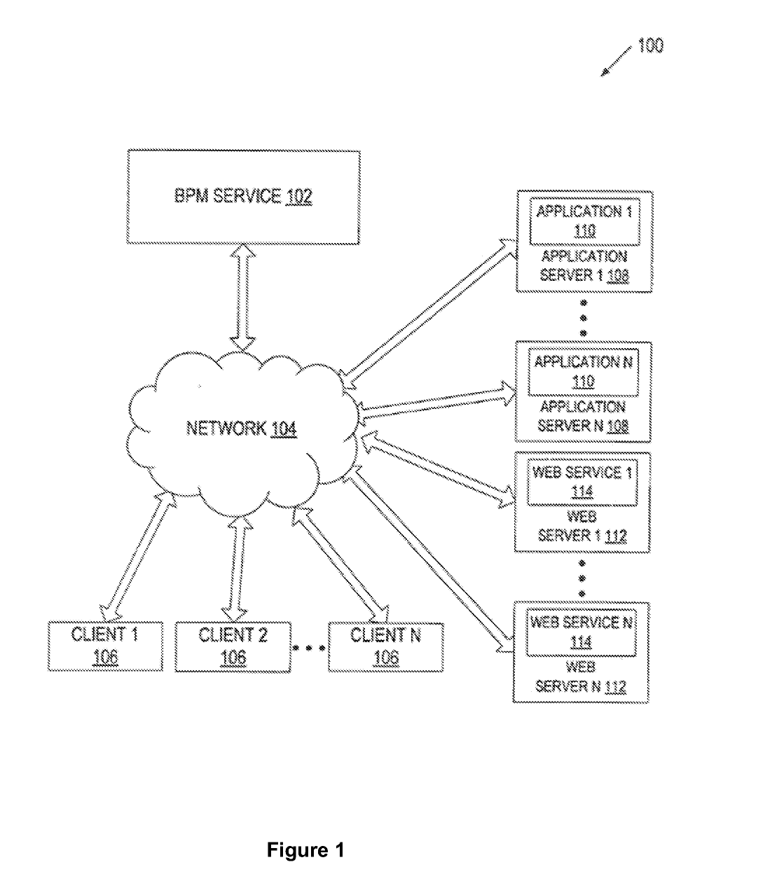

FIG. 1 illustrates an exemplary network architecture 100 in which embodiments of the present invention may operate. The network architecture 100 may include client devices (clients) 106, a BPM service 102 and a network 104. The clients 106 may be, for example, desktop computers, personal computers (PCs), server computers, mobile phones, palm-sized computing devices, personal digital assistants (PDAs), tablet devices, etc.

The clients 106 are coupled to the BPM service 102 via the network 104, which may be a public network (e.g., Internet) or a private network (e.g., Ethernet or a local area Network (LAN)). The BPM service 102 may include one or more servers providing BPM functionality. In particular, the BPM service 102 may allow process developers to define business processes using different business process languages. Some examples of business process languages are JBoss process definition language (jPDL) and business process execution language (BPEL). In some embodiments, the BPM service 102 is implemented using a business process modeling and notation (BPMN) standard, which is a graphical representation for specifying business processes.

jPDL is typically used for Java-centric workflow management, and BPEL is typically used for web service-centric orchestration. Depending on the nature of the business process being modeled, a developer may choose to use jPDL or BPEL to define it. In one embodiment, the BPM service 102 may execute business process definitions using a runtime environment corresponding to the business process language of the relevant business process definition. Clients 106 may host browser applications (not shown) to present user interfaces for defining business processes to users of clients 106. Users of clients 106 may include, for example, process developers, system administrators, business analysts, etc. The user interfaces may be provided to allow users of clients 106 to interact with execution of business processes, monitor the execution of business processes, and view statistics about business process executions.

The network architecture 100 may also include application servers 108 hosting applications 110, and/or web servers 112 hosting web services 114. During execution, business processes may interact with the hosting applications 110 and/or web services 114 by invoking hosting applications 110 and/or web services 114 or exchanging data with the hosting applications 110 and/or web services 114.

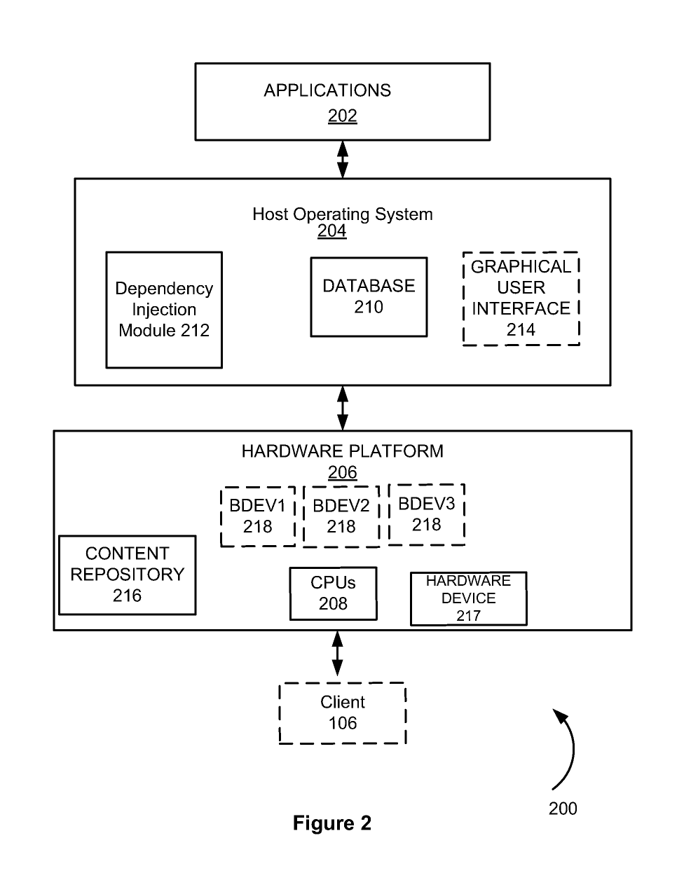

Embodiments of the invention provide systems and methods for BPM service 102 to provide dependency injection. In one embodiment, a dependency injection module is initialized on a host operating system (OS) of BPM service 102. Further description of the dependency injections provided by a BPM system is provided with respect to FIG. 2.

FIG. 2 is a block diagram of one embodiment of a BPM system 200 in which embodiments of the present invention may be implemented. In one embodiment, BPM system 200 is the same as BPM 102 described with respect to FIG. 1. In some embodiments, the BPM system 200 is implemented using a business process modeling and notation (BPMN) standard, which is a graphical representation for specifying business processes. In one embodiment, the BPM system 200 may be a host machine such as, for example, a server computer, a gateway computer or any other suitable computer system that is configurable for operating as a host. As illustrated in FIG. 2, the BPM system 200 may include a hardware platform 206, on top of which runs a host OS 204 that executes one or more software application programs 202 (i.e., applications 202). The host OS 204 may include Microsoft Windows™, Linux™, Solaris™, Mac™ OS or any other suitable operating system for managing operations on the BPM system 200.

In one embodiment, applications 202 executed by host OS 204 include multiple jPDL applications. In some embodiments, the multiple jPDL applications are separate individual jPDL applications or multiple versions of the same jPDL application, or a combination of both. In another embodiment, the applications 202 executed by host OS 204 are multiple BPEL applications. In some embodiments, the multiple BPEL applications may be separate individual BPEL applications or multiple versions of the same BPEL application, or a combination of both.

The hardware platform 206 may include one or more central processing units (CPUs) 208 and a content repository 216. In one embodiment, a content repository 216 is a store of content that allows application-independent access to the content, with the ability to store and modify the content in addition to searching and retrieving the content. Content repositories 216 are used in content management systems to store content data and metadata associated with the content data (such as versioning metadata). In one embodiment, the content repository 216 stores processes modeled by BPM system 200, including sub-processes associated with each process and metadata associated with each sub-process.

In one embodiment, the content repository 216 is implemented as one or more hardware and/or software devices, which may be located internally and/or externally to the BPM system 200. Examples of content repository 216 may include, but are not limited to, random-access memory (RAM), non-volatile storage memory (e.g., Flash, EEPROM, solid state drives (SSD), etc.), magnetic storage memory (e.g., one or more hard drives), and optical memory (e.g., CDs, DVD, BlueRay drives, etc.). In addition, hardware platform 206 may include additional hardware devices 117, such as network interface cards (NICs), sound or video adaptors, photo/video cameras, printer devices, keyboards, displays or any other suitable device intended to be coupled to a computer system.

In some embodiments, the hardware platform 206 may also include one or more bus devices (BDEVs) 218. In one embodiment, the BDEVs 218 comprise one or more hardware and/or software devices, which may be located internally and/or externally to the BPM system 200. Examples of the BDEVs 218 include, but are not limited to, universal bus devices (USB), general purpose interface bus (GPIB), local area network (LAN), or any other suitable device intended to couple to a computer system.

In one embodiment, one or more clients 106 may be communicably coupled to the host OS 204. In one embodiment, clients 106 are the same as clients 106 of FIG. 1. Clients 106 may be connected to host OS 204 via a network, such as network 104 of FIG. 1. In another embodiment, the clients 106 may be directly connected to host OS 204 via a BDEV 218 (e.g., BDEV1 218) integrated with the BPM system 200. In an embodiment, the BDEV 218 may be an integrated circuit (IC) separate from one or more CPUs 208. In another embodiment, the BDEV 218 may be integrated with the one or more CPUs 208.

In some embodiments, the host OS 204 includes a dependency injection module 212. The dependency injection module 212 integrates with applications 202 to generate and update metadata associated with sub-processes of business processes modeled by BPM system 200. In some embodiments, the dependency injection module 212 is interfaced by dependency injection application programming interfaces (APIs) to access and retrieve the application 202. In other embodiments, the dependency injection module 212 integrates with applications 202 to search and retrieve metadata from the content repository 216, where the metadata is associated with sub-processes of business processes of the applications 202.

In one embodiment, the host OS 204 may also include a graphical user interface (GUI) 214 configured to allow a user (e.g., a system administrator) to interact with any runtime tasks generated by executing a business process modeled by the BPM system. This GUI may be uniform across all business processes, regardless of business process languages used for process definitions. Alternatively, the programming interfaces used to interact with the business process vary from one language to another. For example, jPDL processes may be accessed through a JAVA API defined for jPDL processes, and BPEL processes may be accessed via a Web service interface defined for BPEL processes. The host OS 204 stores runtime execution data in a runtime execution database 210.

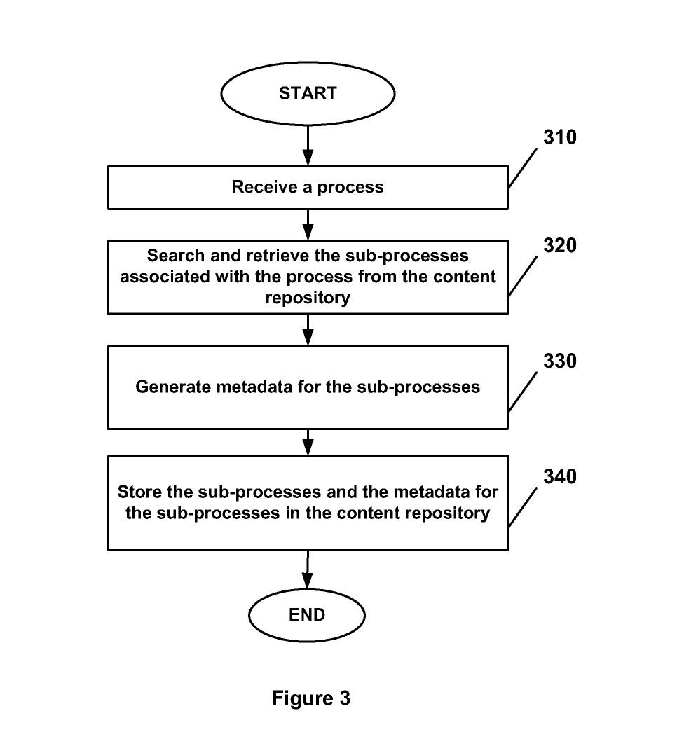

FIG. 3 is a flow diagram illustrating a method 300 for providing dependency injection for a BPM system according to an embodiment of the present invention. In some embodiments, the BPM system is implemented using a business process modeling and notation (BPMN) standard, which is a graphical representation for specifying business processes. Method 300 may be performed by processing logic that may comprise hardware (e.g., circuitry, dedicated logic, programmable logic, microcode, etc.), software (such as instructions run on a processing device), firmware, or a combination thereof. In one embodiment, method 300 is performed by the dependency injection module 212 of BPM system 200 of FIG. 2.

Method 300 begins at block 310 where a process (e.g., a business process) is received by a host OS 104 of a BPM system 200. In one embodiment, the process is sent by a developer in the BPM system, and is related to development of a business process for a client of the BPM system. As discussed above, a process is a series of steps or activities performed to achieve a business goal. The process includes one or more sub-processes. A sub-process is a step or activity performed in the process, which includes an incoming connection and an outgoing connection. The execution of a sub-process by the parent process depends on input variables existing at a time that the process is executed. As a result, in some iterations of the parent process, a sub-process may be executed by the parent process, while in other iterations, the same sub-process is not executed.

In one embodiment, the process includes one or more parameters that trigger the creation of metadata for a sub-process of the process. For example, the process may have a business goal of providing discounts for customers. As a result, the parameters specified by the process may include categories of customers associated with the process, where each customer category is associated with a different type of discount. As an example, the categories of the customers may include, but are not limited to, a gold customer, a silver customer and a bronze customer.

At block 320, the dependency injection module searches the content repository of the BPM system and retrieves the sub-processes associated with the received process. In one embodiment, the parameters received with the process determine which sub-processes to be retrieved from the content repository. Referring back to the example above, the sub-processes retrieved are a first sub-process, a second sub-process, and a third sub-process. The first sub-process is associated with the gold category customer, the second sub-process is associated with the silver category customer, and the third sub- is associated with the bronze category customer.

At block 330, the dependency injection module generates metadata for the retrieved sub-processes based on the received parameters. As discussed in the example above, the parameters specified by the process may include categories of customers associated with the process, where each customer category is associated with a different type of discount (i.e., a sub-process). For example, customers of the gold category may receive a twenty percent discount. Accordingly, metadata representing the twenty percent discount is generated and associated with the first sub-process of the gold category customers. Similarly customers of the silver category may receive a ten percent discount. Accordingly, metadata representing the ten percent discount is generated and associated with the second sub-process. Likewise, customers of the bronze category may receive a five percent discount. Accordingly, metadata representing the five percent discount is generated and associated with the third sub-process. Then, at block 340, each of the sub-processes and the generated metadata for the sub-processes are stored in the content repository.

In one embodiment, the process may specify parameters that trigger an update to already-existing generated metadata associated with a sub-process of the process. In this scenario, the sub-process and the already-existing metadata for the sub-processes are retrieved from the content repository. The metadata for the sub-processes is updated according to the new received parameters. Then, each of the sub-processes and the updated metadata for the sub-processes are stored in the content repository.

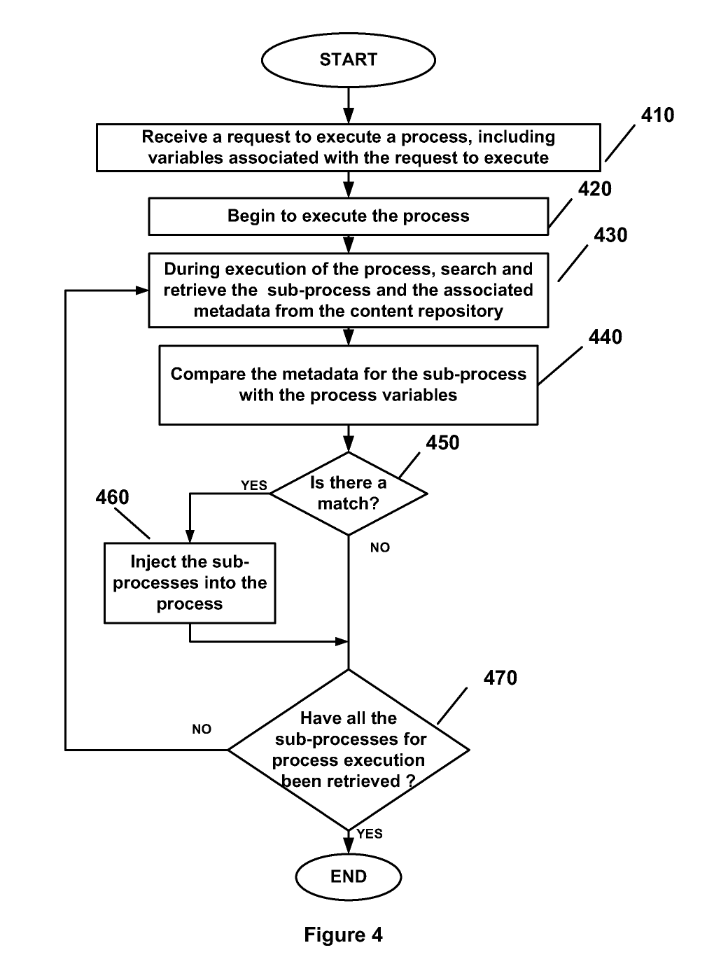

FIG. 4 is a flow diagram illustrating a method 400 for providing dependency injection for a BPM system according to another embodiment of the present invention. In some embodiments, the BPM system is implemented using a business process modeling and notation (BPMN) standard, which is a graphical representation for specifying business processes. Method 400 may be performed by processing logic that may comprise hardware (e.g., circuitry, dedicated logic, programmable logic, microcode, etc.), software (such as instructions run on a processing device), firmware, or a combination thereof. In one embodiment, method 400 is performed by the dependency injection module 212 in the BPM system 200 of FIG. 2.

Method 400 begins at block 410 where a request to execute a process is received by a host OS 204 of a BPM system. In one embodiment, the request to execute the process is sent by a developer in the BPM system. In another embodiment, the request to execute the process is sent by a client. The request received at block 410 may further include one or more variables associated with the execution of the process. Referring to the above-described example, the request to execute the process may be received with a variable that identifies the customer type (e.g., gold, silver, bronze) for which the process is executed. At block 420, the dependency injection module begins to execute the process. During execution of the process, at block 430, the dependency injection module retrieves one or more sub-processes and associated metadata (of the sub-processes) from the content repository, where the retrieved sub-processes/metadata are associated with the process. At block 440, the dependency injection module compares the metadata for the sub-process with the received variables of the process requested to be executed.

At decision block 450, it is determined if there is a match between the process variables and the metadata associated with the sub-processes. If it is determined that there is not a match at decision block 450, the method 400 proceeds to decision block 470, described below. On the other hand, if it is determined that there is a match at decision block 450, then method 400 continues to block 460, where the sub-process is injected into the process. In one embodiment, injecting a sub-process into the process includes inserting the code of the sub-process into the code of the parent process to order for the parent process to include the execution of the sub-process. The sub-process then provides a step or activity needed to execute the process in the particular circumstances.

Referring back to the above example, the process may have been received with the variable identifying a gold customer type for which the process is executed. As a result, the sub-processes that have the metadata matching a gold customer type are selected and injected into the process. This simplifies the creation of the parent process by the BPM system as branching logic for multiple different sub-processes does not have to be hard coded into the parent process code.

At decision block 480, it is determined if the all of the sub-processes associated with the parent process have been retrieved from the content repository and examined. If at decision block 480, it is determined that all sub-processes associated with the parent process have not been retrieved/examined, then method 400 returns to block 430 to continue retrieving and comparing metadata of sub-processes associated with the parent process. If at decision block 480, it is determined that all sub-processes associated with the parent process have been retrieved and examined, then the method 400 ends.

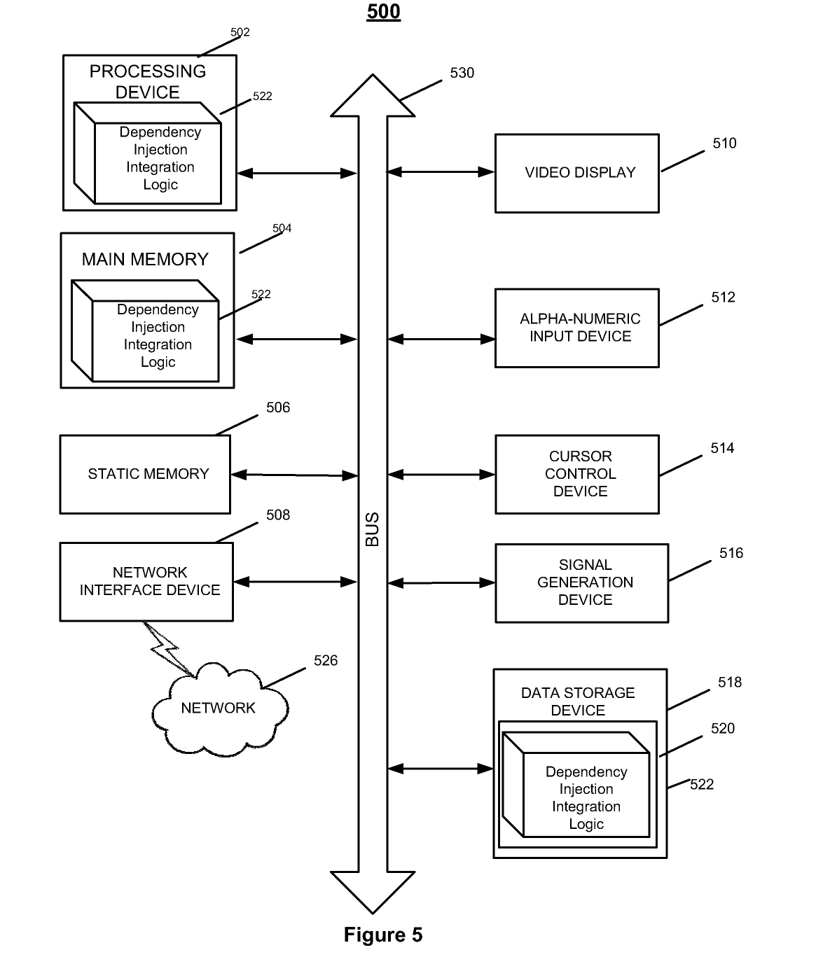

FIG. 5 illustrates a diagrammatic representation of a machine in the exemplary form of a computer system 500 within which a set of instructions, for causing the machine to perform any one or more of the methodologies discussed herein, may be executed. In alternative embodiments, the machine may be connected (e.g., networked) to other machines in a LAN, an intranet, an extranet, or the Internet. The machine may operate in the capacity of a server or a client machine in a client-server network environment, or as a peer machine in a peer-to-peer (or distributed) network environment. The machine may be a personal computer (PC), a tablet PC, a set-top box (STB), a Personal Digital Assistant (PDA), a cellular telephone, a web appliance, a server, a network router, switch or bridge, or any machine capable of executing a set of instructions (sequential or otherwise) that specify actions to be taken by that machine. Further, while only a single machine is illustrated, the term “machine” shall also be taken to include any collection of machines that individually or jointly execute a set (or multiple sets) of instructions to perform any one or more of the methodologies discussed herein.

The exemplary computer system 500 includes a processing device 502, a memory 504 (e.g., read-only memory (ROM), flash memory, dynamic random access memory (DRAM) (such as synchronous DRAM (SDRAM) or Rambus DRAM (RDRAM), etc.), a static memory 506 (e.g., flash memory, static random access memory (SRAM), etc.), and a data storage device 518, which communicate with each other via a bus 530.

Processing device 502 represents one or more general-purpose processing devices such as a microprocessor, central processing unit, or the like. More particularly, the processing device may be complex instruction set computing (CISC) microprocessor, reduced instruction set computer (RISC) microprocessor, long instruction word (VLIW) microprocessor, or processor implementing other instruction sets, or processors implementing a combination of instruction sets. Processing device 502 may also be one or more special-purpose processing devices such as an application specific integrated circuit (ASIC), a field programmable gate array (FPGA), a digital signal processor (DSP), network processor, or the like. The processing device 502 is configured to execute dependency injection logic 522 for performing the operations and steps discussed herein. In one embodiment, dependency injection module 212 described with respect to FIG. 2 performs the dependency injection logic 522.

The computer system 500 may further include a network interface device 508. The computer system 500 also may include a video display unit 510 (e.g., a liquid crystal display (LCD) or a cathode ray tube (CRT)), an alphanumeric input device 512 (e.g., a keyboard), a cursor control device 514 (e.g., a mouse), and a signal generation device 516 (e.g., a speaker).

The data storage device 518 may include a machine-accessible storage medium (or more specifically a computer-readable storage medium) 520 on which is stored one or more sets of instructions (e.g. dependency injection module logic 522) embodying any one or more of the methodologies of functions described herein, such as method 300 and a method 400 for providing dependency injection in a BPM system described with respect to FIGS. 3 and 4 respectively. In some embodiments, the BPM system is implemented using a business process modeling and notation (BPMN) standard, which is a graphical representation for specifying business processes. The dependency injection module logic 522 may also reside, completely or at least partially, within the memory 505 and/or within the processing device 502 during execution thereof by the computer system 500; the memory 505 and the processing device 502 also constituting machine-accessible storage media.

The machine-readable storage medium 520 may also be used to store the dependency injection module logic 522 persistently containing methods that call the above applications. While the machine-accessible storage medium 520 is shown in an exemplary embodiment to be a single medium, the term “machine-accessible storage medium” should be taken to include a single medium or multiple media (e.g., a centralized or distributed database, and/or associated caches and servers) that store the one or more sets of instructions. The term “machine-accessible storage medium” shall also be taken to include any medium that is capable of storing, encoding or carrying a set of instruction for execution by the machine and that cause the machine to perform any one or more of the methodologies of the present invention. The term “machine-accessible storage medium” shall accordingly be taken to include, but not be limited to, solid-state memories, and optical and magnetic media.

It is to be understood that the above description is intended to be illustrative, and not restrictive. Many other embodiments will be apparent to those of skill in the art upon reading and understanding the above description. Although the present invention has been described with reference to specific exemplary embodiments, it will be recognized that the invention is not limited to the embodiments described, but can be practiced with modification and alteration within the spirit and scope of the appended claims. Accordingly, the specification and drawings are to be regarded in an illustrative sense rather than a restrictive sense. The scope of the invention should, therefore, be determined with reference to the appended claims, along with the full scope of equivalents to which such claims are entitled.

1. A method comprising:
receiving, by a processor hosting a business process model (BPM) system, a process and a plurality of parameters of the process;
retrieving sub-processes associated with the process from the processor;
generating, by the processor, metadata for the retrieved sub-processes in view of the plurality of parameters; and
selecting, in view of the generated metadata and a variable of the process, a sub-process from the retrieved sub-processes for injection into the process when the process is executed.

2. The method of claim 1 wherein the parameters trigger the generating of the metadata.

3. The method of claim 1 further comprising storing the retrieved sub-processes and the generated metadata for the retrieved sub-processes.

4. The method of claim 1, further comprising:
receiving additional parameters with the process;
updating the generated metadata for the retrieved sub-processes in view of the additional parameters; and
storing the updated metadata in.

5. The method of claim 1 wherein in the process is created by the BPM system prior to receiving the process and the parameters.

6. The method of claim 1 wherein a sub-process of the retrieved sub-processes is selected for injection into the process when the generated metadata for the sub-process matches the variable of the process received in a request to execute the process.

7-9. (canceled)

10. A system, comprising:
a memory; and
a processor coupled to the memory, wherein the processor to:
host a business process model (BPM) system;
receive a process and a plurality of parameters of the process;
retrieve sub-processes associated with the process;
generate metadata for the retrieved sub-processes in view of the plurality of parameters, and
select in view of the generated metadata and a variable of the process, a sub-process from the retrieved sub-processes for injection into the process when the process is executed.

11. The system of claim 10 wherein the processor to store the retrieved sub-processes and the generated metadata for the retrieved sub-processes, wherein the parameters trigger the generate of the metadata.

12. The system of claim 10 wherein the processor to:
receive additional parameters with the process;
update the generated metadata for the retrieved sub-processes in view of the additional parameters; and
store the updated metadata.

13. The system of claim 10 wherein the process is created by the BPM system prior to receiving the process and the parameters, wherein a sub-process of the retrieved sub-processes is selected for injection into the process when the generated metadata for the sub-process matches the variable of the process received in a request to execute the process.

14. (canceled)

15. A non-transitory machine-readable storage medium having instructions stored thereon that, when accessed by a processor, cause the processor to perform operations comprising:
receiving, by the processor hosting a business process model (BPM) system, a process and a plurality of parameters of the process;
retrieving sub-processes associated with the process from the processor; and
generating, by the processor, metadata for the retrieved sub-processes in view of the plurality of parameters; and
selecting, in view of the generated metadata and a variable of the process, a sub-process from the retrieved sub-processes for injection into the process when the process is executed.

16. The non-transitory machine-readable storage medium of claim 15 wherein the processor to perform the operations further comprising:
storing the retrieved sub-processes and the generated metadata for the retrieved sub-processes, wherein the parameters trigger the generating of the metadata.

17. The non-transitory machine-readable storage medium of claim 16 wherein the processor to perform the operations, further comprising:
receiving additional parameters with the process;
updating the generated metadata for the retrieved sub-processes in view of the additional parameters; and
storing the updated metadata.

18. The non-transitory machine-readable storage medium of claim 16 wherein the process is created by the BPM system prior to receiving the process and the parameters, wherein a sub-process of the retrieved sub-processes is selected for injection into the process when the generated metadata for the sub-process matches the variable of the process received in a request to execute the process.

19-20. (canceled)

21. The method of claim 1 wherein the parameters determine the retrieving of the sub-processes.

22. The method of claim 1 wherein the variable is in view of time when the process is executed.

23. The system of claim 10 wherein the parameters determine the retrieve of the sub-processes.

24. The system of claim 10 wherein the variable is in view of time when the process is executed.

25. The non-transitory machine-readable storage medium of claim 15 wherein the parameters determine the retrieving of the sub-processes.

26. The non-transitory machine-readable medium of claim 15 wherein the variable is in view of time when the process is executed.
